(19) United States
(12) Patent Application Publication
(10) Pub. No.: US 2004/0199266 A1
(43) Pub. Date: Oct. 7, 2004

(54) Equipment and methods for real time application

(76) Inventor: Arthur Philip Young, Maldon (GB)

Correspondence Address: A. P. YOUNG, CHASE END, THE DOWNS, MALDON, ESSEX, CM9 5HR, GB

(21) Appl. No.: 10/770,556

(22) Filed: Feb. 3, 2004

(30) Foreign Application Priority Data
Feb. 4, 2003 (GB) 0302602.8

(51) Int. Cl. G05B 15/00

(52) U.S. Cl. 700/1

(57) ABSTRACT

The invention is based on theory, believed to be original, of structure in real time systems. It proposes equipment conforming to this structure, with a method of defining a requirement in terms of rules governing a data structure and the times at which components of the structure are recorded. The data structure consists of a set of lists containing all run-time data and organised in a hierarchy in which an entry of one list may contain particular values, or the latest-available values, of other lists. Theoretical limits on concurrency are proposed, with methods of observing them. Response time performance is adjustable without prejudice to functional performance. Compared with current methods coupling is reduced, improving support for modular structure.

References Cited: BRITISH APPLICATION NUMBER 0302602.8 FILED Feb. 4, 2003. PRIORITY IS CLAIMED.

BRITISH PATENT SPECIFICATION NUMBER 2255842, GRANTED MARCH 1995

First sentence of British Application Number 0302602.8:

The invention sets out a theoretical model to describe how information is generated in physical systems.

Federally sponsored Research or Development: Not Applicable.

### BACKGROUND OF THE INVENTION

The invention relates to real time computer systems. Such a system is used to control the course of a process as it proceeds, sending control signals to direct the course of the process. A process may serve commercial, industrial, military, communications or other purposes.

Prior art is primarily based on the “Communicating Sequential Processes” model due to C. A. R. Hoare of Oxford University in the United Kingdom. The Ada language, and particularly its rendezvous feature, follow a similar approach. Both are familiar to those working in this field. I am not aware of other significant contributions.

These methods have proved difficult to apply, particularly in complex applications. They provide practical approaches to the problems of design, developed through experience, but there is to my knowledge no theoretical argument to support use of these methods rather than others. The methods do not provide a satisfactory way of expressing requirements. It is desirable that the model, used to specify requirement, should take a form similar to that adopted in design, for example to facilitate checking. The technology does not, to my knowledge, provide this facility. Use, in current practise, of the handshake interface to pass messages between processes appears arbitrary, introduces complexity and hinders the adjustment of response time performance as processes exert timing constraints on each other.

An improved approach to structure can, I believe, be achieved by studying the physics of information systems and of signalling. The invention proposes the use of a different logical structure for use in requirement specification and in design, based on such studies. I believe it to offer simpler, faster, less expensive and more certain methods of realising real time systems, as well as improvements in system quality and flexibility.

### BRIEF SUMMARY OF THE INVENTION

The object of the invention is to provide simpler, faster and more economic methods of realising real time systems, at the same time improving the flexibility and the dependability of designs, easing in-service enhancements. The invention recognises a logical structure to which all real time systems are believed to conform, proposing acceptance of this structure in its simplest-possible form while avoiding arbitrary conventions such as the handshake interface convention.

According to the invention run-time data consists of lists organised in hierarchies, entries of some lists containing other lists. As a system runs new entries are appended to its lists, their content derived from the content, at the material times, of these lists. The mechanisms, performing these actions, may run concurrently within certain limits; theoretical limits on concurrency are identified and ways of staying within them are provided. The logical transformations effected by these mechanisms dictate the nature of the facilities offered by the real time system; response time performance is independent, dictated by the methods used to initiate actions of mechanisms and by the speeds of these actions. Requirement specifications are expressed as rules governing behaviour of a similar model.

### DRAWINGS

There are no diagrams or drawings.

### DETAILED DESCRIPTION OF THE INVENTION

This description consists of two parts,the first a technical paper to explain the invention and the theory underlying it, theory which is considered important in providing a full understanding of the invention and in gaining acceptance for its methods; the second part provides a guide to the claims.

### TECHNICAL PAPER

1) Introductory Summary.

Within computers as elsewhere, information is communicated only by signalling. According to this paper, signalling theory suggests that all real time systems conform to a particular logical structure; however failure to recognise this structure has, it is argued, left room for substantial improvement in methods and designs. The theory applies to logical models used to explain or to predict behaviour of physical systems, including real time systems. The proposals aim to provide simpler and more effective methods of system reatisation based on a sound theoretical foundation. Work will be needed to establish these methods; they embrace requirement definition and logical structure, simplifying the approach. By reducing coupling between logical components the support for modular structure is much enhanced while variations, in the mechanisms whereby processing actions are initiated and in the rapidity with which they are performed, allow response time performance to be varied without impairing functional design.

Section 2 presents a method of describing physical behaviour based on ordinary signalling theory: a description of behaviour is information signalled, according to a chosen convention, by the occurrence of behaviour of a corresponding class. Such a convention will be called a “describing convention”. A physical observer can use the method to generate a description and to extend it by observation and also by inference based on experience. The choice of describing convention decides which kinds of behaviour are noted, and the terms used to denote their occurrence. Signals may, or may not, be tested by physical receivers.

According to the theory, past behaviour of any real time system can be described by a set of lists each representing data previously communicated within the system, the lists organised in hierarchies within which some entries contain other lists and/or particular values of them. Each such list results from the application of a particular describing convention, the order of listing of entries representing the time-order in which signalling of their initial values becomes complete. Any design is a particular way of generating data conforming to this structure and to a requirement stating the properties required of a data structure of the same form. In certain designs the concurrent processing of data would cause malfunction; theoretical limits on concurrency are set out. A data structure of this kind, with means of generating its content without further restriction, provides a framework for requirement specification and for design.

Section 3 proposes specific methods, including methods of confining concurrency within the fundamental limits. As the writing of data is non-destructive, readers and writers can operate concurrently subject only to these limits. An approach to requirement definition is also outlined. The proposed methods require an operating environment which includes facilities for garbage collection and recycling, a topic which is also addressed briefly.

2). Theory.

Episodes.

In the (Newtonian) model proposed, physical behaviour consists of episodes. An episode h is any region of space-time within which the pattern of physical conditions —of whatever kinds—conforms to a criterion identified by h. The criterion is applied as time advances, treating time as a vector; it may, or may not, specify conditions in all parts of the space-time region. The chosen describing convention relates the criterion or test, applied to the physical conditions, to the information h. In a sentence such as “The green car scraped the wall between mid-day and one o'clock” the nouns and adjective represent episodes containing the lives of objects (of the car throughout a period while it was green, and of the wall), the verb describes an interaction affecting the courses of these episodes, and “between mid-day and one o'clock” identifies an episode in a clock, an episode which was proceeding as the scraping took place. The sentence denotes an episode containing all these episodes—a first episode is said to lie within a second if its space-time region is contained in that of the second.

An episode of some given class such as h-start may be defined to be the shortest episode containing the start of an episode h.

The material content of the space of an episode may vary during its life—for example the space might contain “the fuel in the tank of the car” or “the tools in the toolbox” throughout the life of the car or of the toolbox. The criterion may, or may not, provide a method of recognising the spatial boundary of an episode during its life; thus it may specify that the space is, at all times, the minimum space containing conditions which satisfy the criterion. Our episodes will take place within a real time system and its environment. By convention an episode will always begin, and end, with physical changes specified by the criterion. As a car (like a real time system) will have various component parts, such as its controls, the occurrence of an episode car implies the occurrence of other episodes—such as the histories of its controls—within that episode.

A physical system may contain physical systems of various classes, the number of physical systems of any given class (such as the number of books in a library) varying with time. Equally the number of transaction-sequences in progress in a system (for example the number of contracts currently being negotiated) may vary with time. Thus in describing the behaviour of a physical system we must be able to describe behaviour of members of its time-varying populations, as well as describing variations in other physical properties of the system.

Reasoning and Goal-Seeking.

A physical observer, using this method of describing physical behaviour and observing the occurrence of an episode of a first class, may be able to infer from experience that the occurrence, or the non-occurrence, of an episode of some second class is implied: thus a glimpse of a car may imply, to the observer, the occurrence of the life of that car; and the knowledge that momentum is always conserved may assist prediction of the behaviour of colliding objects. Probabilities may also be employed in descriptions, knowledge of probabilities gained from episodes each containing numerous trials. Thus a coin-tossing episode, known to occur, may prove to be an episode of class “heads” or of class “tails”, with equal probability.

According to this model, reasoning about behaviour is based on knowledge of the probability that an episode of some first class, known to occur, will prove to do so within an episode of some postulated second class. Such knowledge may be gained by experience or by inference based on experience. In this way—the scientific method—the observer may employ inference to extend a description to embrace unobserved behaviour, past and future. The observer may also be motivated to seek out episodes of pleasurable classes and to avoid those of painful classes; this suggests a mechanism capable of supporting motivation.

Communication.

The communication of a message m—of whatever form—through a physical path a according to a signalling convention c can now be defined as an episode (m, a, c). The combination (a, c) constitutes an identifier for a communications channel. Here we shall use the signalling convention to define the describing convention, the former included within the latter.

Where signalling of data is to be described we shall employ episodes each of which terminates immediately after sufficient behaviour has occurred to signal its class; the data, signalled by the occurrence of an episode, becomes accessible to its readers when the episode ends. This convention is chosen because it describes communication; it also allows us to define the time order, in which episodes occur, as the time order in which they terminate. Behaviour can be described only in terms of the classes of the episodes it contains and of their time order of occurrence; a description is a statement of the class of an episode.

Modelling.

Within the memory of a suitably-equipped observer or system the occurrence of an episode z′ may represent the occurrence of a corresponding episode z, past or future, in the environment of that observer, thus creating an episode-model. Where every episode, of a class capable of occurring in a first physical system under a first describing convention, is also capable of occurring in a second physical system under a second describing convention, and conversely, then each physical system is a model of the other under these conventions.

In a real time system the input data, often supplemented by data derived from processing, is recorded; these recording episodes model behaviour outside the system, at the same time making a description of external behaviour accessible to its readers within the system. This model is used to cause behaviour which controls the course of that behaviour.

Data Structure.

Data from any source can clearly be represented as a time-ordered list in which each new item of information is appended to the list, supplementing the information it contained while preserving time-order information relating the entries within each list. Thus each source of data can be expressed in the form of a list without loss of information. The content of the entry and the identity of the list together define the class of an episode. Where two items result from episodes which terminate nearly simultaneously their time order will become indeterminate and may have to be assigned arbitrarily; clearly designers will ensure that time order, when used to communicate significant information, is identifiable with certainty.

When each source of data is represented by a list, readers can use a fixed procedure to identify the last-appended member of the list, using the current content of the list in computations; for example the address of the last-appended entry of the list may occupy a fixed memory location, its value changed only in atomic or indivisible actions. The fitness of a value of a list for any given purpose is dictated first by its derivation and second by timing considerations discussed under “Concurrency” later in this part of the account. In our model writers operate by appending entries to lists non-destructively, creating a need to discard entries which are no longer needed (see under “Garbage-collection and Recovery” in Section 3 below).

It is useful to extend the basic list structure, adopting hierarchic structures for particular purposes as will be explained in the following paragraphs. Within such a structure an entry of a higher level list will contain (by value or by reference) lower level lists.

We now consider the uses of list hierarchies.

First, parts of an entry may be unknown when the entry first enters the list, becoming known later. These parts may be written into the entry when they become known, each such part assigned a boolean which is set true only when that part has been written. Each part is, in effect, an entry within a list of such parts, each such list containing one entry or more. This arrangement also allows data to be supplemented, amended or deleted non-destructively. For example an entry, initially containing the results of measurements or of computations, may be extended to contain the results of further computations based on data derived using the entry or indeed using the list of which it is the last-appended entry. The content of other lists may also be used in such derivations.

This arrangement allows data, computed using a particular value or entry of a list, to be associated with that value or entry.

Second a designer may foresee a need to describe, in greater detail at run-time, an unknown number of episodes of some given class. For example the designer foresees that a library will need books and borrowers, each having a “life in the library”, the number of such episodes unpredictable at design-time. The designer also foresees the need to describe these episodes in more detail at run-time, to report borrowing transactions and other behaviour: The designer therefore establishes a list in which each entry identifies the books and borrowers currently in the library, providing pointers to lists, or to sets of lists, each list containing the history of a particular book or borrower as viewed using a specific describing convention. Entries may be appended to these lower level lists—in our example, some lists may serve to report borrowing transactions as they occur—as well as to the higher level list; in the simplest case each pointer points, directly or indirectly, to the last-appended entry of a lower level list.

It is to be noted that a hierarchy may employ any number of levels: thus a library might be part of a library network, a list describing the history of the network having entries containing pointers to lists each giving the history of a library which has belonged within the network. It is also to be noted that the lives of particular transaction sequences or contracts, rather than of particular physical objects or persons, may equally be described in lower level lists of a hierarchy in this way. (Alternatively a design may of course provide enough lists to accommodate the largest-possible populations, lists remaining empty when not in use).

Third, a different arrangement is needed where the occurrence of a transaction—for example of a borrowing transaction in a library—is reported only in lists giving the histories of the participants in the transaction, here those of the book and of the borrower. A reader, reading the content of these lists, may gain inconsistent accounts, finding that transactions reported in one list are absent from the other (we impose no timing constraints on readers except as described under “Concurrency” below). Inconsistency can be avoided where necessary by introducing a higher level list in which each transaction is reported by entries each identifying a particular entry in each list giving the history of a participant in the transaction—in our example, of lists associated with the book, and with the borrower, of each transaction reported by the higher level entry. Then a reader, accessing the lower level lists through the higher level list, will obtain consistent values of the two lower level lists regardless of when reading takes place; these values will report the effect of all transactions of some given set and of that set only.

In all cases where the occurrence of a single episode causes entries to be appended to two lists or more, inconsistency may result. Simultaneous publication can be achieved only by noting the occurrence of a single episode describing interactions, the class of this episode used to publish the description; the field of view must be broadened so that the interactive behaviour of all participants in the interaction occurs in a single episode.

In some applications a number of transactions may be processed in one operation, appending entries to the lower level lists before appending a single entry to the higher level list, an action which publishes the results of the processing operation. Each entry of the higher level list then identifies those entries, in the lower level lists, which end the block-reports.

Processing.

Information is generated, communicated and processed only in episodes: an episode {i, o, p} might represent the occurrence of a processing episode p (employing sensing, measurement and computation in some combination) which detects the occurrence of a set of episodes which communicate data i to the processing mechanism, and which causes a set of episodes o to occur in response, thus signalling the set of output data o.

Each member of these sets i and o is then an ordered pair containing the identity and the value of an item, this an item either of input information within i or else of output information within o. It is notable perhaps that the class {i, o, p} of a processing episode can be expressed as a Prolog fact p(i, o) where p implements a rule of the form p(I, O). This fact is communicated by the occurrence of the processing episode. Where i and o are both generated by processing episodes which are themselves successions of processing episodes, both i and o may consist of lists in which each entry is generated by one of these latter processing episodes.

Some lists may describe the states of clocks, their entries appended at discrete time intervals, albeit with some degree of inaccuracy. A description of the life of a physical system will normally employ one list for each processing episode contributing to the overall description.

Real Time Systems.

We can regard the life of a real time system as an episode which begins when the manufacture of the system starts and which contains a succession of “runs”, each run itself an episode. The manufacturing and operating specifications form part of the class of the “system life” episode, thus ensuring a high probability that any given run will conform to requirement. The loading of software is seen as a manufacturing activity.

The run-time data of a real time system provides a more detailed description of the class of the particular run. It consists, according to this account, of two parts: the first a description or model of behaviour occurring outside the real time system, the second a description, derived from this first part, of behaviour caused to occur within the real time system in order to control behaviour outside it.

Synchronism.

Within signalling systems the magnitudes of time intervals may also be coded in order to communicate values or logical relationships. Synchronism may be used to signal a reference—for example the entry, placed in a second list immediately after an entry has been placed in a first list, may bear a special relationship to that first entry.

Where all input data (including clock readings), supplied to a real time system, take the form of lists which remain permanently recorded while needed, readers of input data do not need to measure any time interval; designers may exploit any rules known to govern the time intervals between the arrival of new entries in an input list. The subsequent processing consists of purely logical operations in which times and time intervals are represented only by numbers. There appears to be no reason for a designer to arrange for information to be communicated, in the course of purely logical processing, by coding a time interval; discussion of this topic therefore seems pedantic. Further, if certain time intervals are coded for communication they cannot later be varied to facilitate adjustment of response-time performance, unless by changing the unit of time. The time domain would be overloaded.

We adopt the convention that the time interval, separating events in two episodes each described by an entry within its list, cannot be coded; the magnitudes of such intervals have no logical significance. Alternative methods of coding values or relationships must be used or a different describing convention must be chosen.

Concurrency.

Two logical defects, here called “cross-talk” and “regression”, may arise in real time systems as a result of concurrent processing, and must be avoided:

Cross-talk will arise if a value of a list is acquired and is used in deriving its next value, and if the content of the list is altered by a concurrent operation while this acquire/derive/write operation is in progress. A value may be “acquired” either by reading the content of a list, or else by appending an entry (or entries) to its previous value thereby gaining access to its current value. As a new value of a list is created by appending at least one entry to its previous value, this previous value must be used in deriving any new value.

Regression may arise if two acquire/derive/write operations occur concurrently, each of which acquires the content of a first list, using it in deriving the next entry of a second (different) list. If the time duration of one acquire/derive/write operation is contained within that of the other then the time order of the acquiring actions will not match the time order of their corresponding writing actions. This cannot be permitted as the latest entry of a list should always reflect the most up-to-date information available. Regression may occur in hierarchic systems if a value of a lower-level list is created and is then referenced in a new entry of a higher-level list, without precautions.

Regression may also occur if the content of the first list is also used to derive entries of a third list, the content of the third list also used to derive entries of the second. In such indirect cases of regression the first and third lists should be accessed through a higher level list using the hierarchic methods described above. This list can then be the resource claimed to gain protection, using the protection method described in Section 3 below.

No other constraint on concurrency appears necessary.

3). Proposals for Structural Design.

The proposals for improved methods are based on the avoidance of arbitrary conventions, the theoretical model restricted only insofar as clear advantages result. Existing methods can be applied within the framework proposed as it is not restrictive; however some methods introduce their own restrictions, losing the advantage sought.

Proposed Methods.

In the methods proposed all run-time data are held in lists. Each real time clock is represented as a list of times, generated autonomously; other input data are also provided within autonomously-generated lists. New entries are appended to internally-generated lists by mappings. A mapping lasts for a finite period of time. A mapping may read from any chosen set of lists and may append entries to any other chosen set of lists (one entry or more). It may also leave all lists unaltered—for example where each message of a message sequence is to be processed by a mapping if available, and the mapping finds that the next message due for processing has not yet reached the list to which the sequence is written; the mapping then leaves all lists unaltered, terminating when complete. Communication between mappings is permitted only through the lists of run-time data.

The times, at which mappings append entries to lists, have no logical significance (other than to determine the order in which entries appear within their lists); all run-time data, and all references from one entry to another, are communicated to mappings by data within entries, not by control of the magnitude of any time interval between appending actions. In this way a purely symbolic representation of the lists and of logical relationships between their entries is achieved. Any data-set, received by a mapping using sensing actions performed simultaneously or at an in-built time interval (synchronously), is defined to form part of a'single entry. This allows timing variations to be used to adjust response-time performance, the logical design remaining valid despite these variations. Designers may of course exploit knowledge of time intervals at which entries reach input data. Entries are held within lists until their readers no longer require access to them.

An entry may contain a number of fields, the content of each field a data-set marked by a boolean marker to indicate whether its value is yet recorded within the entry. Some mappings may assign values to these fields, and may operate concurrently on different fields. Such a field is a primitive form of list—an entry may also include lists. This arrangement allows values to be written within an existing entry, even within an entry of an input list; it also allows functions of the initial value of an entry to be written into the entry. Corrections and amplifications of previously-recorded entries may also be appended, avoiding destructive amendment.

Structure in Design.

The logical or functional design consists of a set of procedures, each procedure operating on lists of which the identities are supplied to the procedure where necessary; semaphores, used to maintain concurrency within safe limits, are also specified to procedures as explained under the next heading which is “Concurrency Control”. A procedure, operating on a higher level list of a hierarchy, may call a lower level procedure to operate on lower level lists, supplying their identities as parameters; thus a first procedure, operating on a list giving the history of “all the books in the library”, might call a second procedure to operate on a list giving the history of a particular book identified to that second procedure by the first.

All named lists may be used, by a procedure, as sources of information; some also act as destinations for information, a procedure acting to append an entry or entries to the lists it selects, or to leave the content of all lists unaltered. Appending takes place when a boolean variable, or the equivalent, becomes true and signals the joining of the entry to the list. Provided that the measures necessary for concurrency control are followed, mechanisms to initiate these procedures can be chosen at will. The choice will influence the frequency and urgency with which procedures are initiated; these, and the rapidity with which procedures are performed, will dictate response time performance. Consequently functional design is not invalidated by changing response time performance.

A procedure, when called, is said to execute a “mapping”; it returns no results (other than fault reports where needed). A procedure may be initiated whenever the content of any list, of some chosen set, changes, or one procedure may be called by another. As some lists will be devoted to describe the behaviour of clocks, procedures may be called at chosen times as indicated by these lists.

Concurrency Control.

Protection against cross-talk and regression may be provided by treating as unique resources:

First the right to acquire a value of a particular list and to append an entry (or entries) to that value to form a new value of that list (protecting against cross-talk);

Second the right to acquire the values of a set of one or more particular lists for use in deriving a new entry for a particular list, this last list not included in the set (protecting against regression).

A mapping must claim, successfully, each of these resources before proceeding to exercise the rights it confers, thus ensuring that at any given time no more than one mapping will be allowed to exercise these rights in creating a new value of a particular list. A mapping may claim rights by claiming the appropriate semaphore in an indivisible operation. A mapping may need to claim two semaphores or more, some to protect against regression and one to protect against cross-talk. However it will often be possible to use a single semaphore, claimed at the outset of a mapping, to protect against both cross-talk and regression; it will also be possible, in some cases, to use a single semaphore to protect a number of sources of information against regression. Of course variations in the choice of semaphores may influence response time performance.

The ultimate protection is, of course, to require mappings to occur in turn, allowing no concurrency in running mappings. Care must be taken to avoid deadlock due to semaphores; by ensuring that semaphores are always claimed in the time order in which their identities appear in a list, deadlock can be avoided.

In calling a procedure to perform a mapping we must ensure that the procedure can identify the relevant semaphore or semaphores, supplying their identities where needed; often the identities, of the lists on which the procedure is to operate, will suffice.

Processing Messages.

Where messages are to be processed in turn a pointer is required to indicate how far processing, by previous mappings, has progressed. A list, maintained by mappings, will contain successive values of this pointer, each value pointing to a message within the list of messages.

Garbage-Recognition and Recovery.

Discussion of this topic does not cover message-processing applications, where methods of discarding fully-processed messages are well-known; the discussion concerns lists which are entered through their “latest-recorded” entries. Memory-recovery, that is the discarding of entries once their usefulness has passed, becomes essentially a facility provided by the operating environment; this topic is discussed only very briefly.

An entry can be discarded only when its content will not be read again. We can arrange that an entry will be read by a mapping only if it is among the n latest-recorded entries of a list-value acquired by that mapping, where n is an integer chosen for that list. As reading continues new entries may reach the list. Consequently an entry can be discarded only when the time interval, since that entry ceased to be among the n latest-recorded entries of the list, exceeds the time duration of reading of the list-value by any mapping. Time-stamping of entries may help in implementing such arrangements.

An entry in one list may reference an entry in another list, requiring a further constraint on discarding. We may discard such a referenced entry only if all entries, carrying references to it, have been discarded. For this reason it may be desirable to avoid the use of references except in hierarchies, copying data into entries to avoid the need for referencing. We will also avoid signalling methods, such as the use of case-shift in a character stream, in which one entry may affect the interpretation of all subsequent entries of the list.

Intuition suggests that it will often be demonstrably sufficient to store lists in simple cyclic buffers, using memory capacity somewhat lavishly in order to avoid the need for elaborate garbage recognition and recycling. Where mappings can be controlled to last only for periods of time much shorter than the time intervals between arrivals of new input data, memory requirements are reduced. Often mappings will require to read only from the latest entry of the list, a list-capacity of two or three entries sufficient if mappings read only briefly.

Requirement Definition.

A requirement, for a real time system of any kind, may be expressed by first identifying the classes of list which are to be used in requirement specification. Each life of a given class—such as the life of a library, or the life of a book—will be described by a set of one or more lists, each such list generated by the application of a describing convention for describing lives of the given class. Again a language in the style of Prolog may be used to specify, in symbolic terms, the variables to be held in entries of the various lists; these should include the time at which each entry joins its list, then becoming accessible to its readers. For each entry in any list derived within the real time system there must exist values of lists from which that entry was derived; these values must have existed at times consistent with the response-time performance requirement. Consequently a requirement can be specified as a set of Prolog-style rules which give both the derivation (in as much detail as may seem appropriate at the successive stages of the project) and the response-time constraints.

A language of this kind seems well suited to define both the data structures, and the mapping rules, encountered in real time applications.

Relationship to Current Methods.

In current methods processing is performed in concurrent processes, tasks or threads; these synchronise and communicate with each other using a handshake (in Communicating Sequential Processes—CSP), or using the rendezvous (in the Ada language). By convention writing is destructive, a feature which generates potential conflicts between readers and writers, requiring semaphores and monitors for mutual exclusion. In most practical cases current methods appear to provide protection against cross-talk and regression, by ensuring that only one mapping, writing to any particular destination, can exist at any given time; however it is doubtful whether this protection is systematic, nor are these defects explicitly recognised so far as this writer is aware. There appears to be no fundamental physical model to justify these approaches, nor are the underlying data structures fully recognised.

As one would expect, current methods seem capable of implementation using lists and mappings; one list might represent the internal data of each process or thread, another each source of data shared with other processes and yet another might be allocated to each of its message-passing channels .to hold messages and control signals. A higher-level list may also be needed to maintain consistency between these lists, or the list devoted to internal data might suffice. CSP uses the “co-ordination” provided by the handshake to gather together results derived, by concurrent processes, from a single value-set; this can be achieved, in the lists/mappings model, by including the original value-set, and the derived value-sets, in a single entry while using booleans to show which value-sets are already recorded.

Compared with current methods the lists/mappings structure offers reduced coupling as the handshake is used only in applications (such as error-correction in communications systems) which require it; as a result, design of logic and of response-time performance are simplified and independent. Current methods also restrict performance. The proposals allow run-time data to be read by mappings introduced to implement new facilities, enabling many requirement extensions to be implemented by extending, rather than by altering, existing designs. A common structure is used for all phases of a project, from requirement-definition to in-service enhancement. Application-specific software is insensitive to changes in run-time environment, for example allowing varying numbers of physical processors to be used to run it. The re-use of software in diverse applications may also become easier. The lists/mappings model also lends itself to modelling, an aid to requirement definition and testing. The need for garbage collection mechanisms complicates the operating environment but may reduce the work-load of the applications designer and the scope for error.

Petri nets can also be represented within the lists/mappings structure.

### A GUIDE TO THE CLAIMS

All claims relate either to real time systems used to control useful processes of whatever kind, or to methods of realising such systems and of specifying requirements for such systems.

All claims except the last provide a real time system in which lists are used to store run-time data, and in which updating operations are performed; the last claim provides a method of specifying requirements for real time systems, a requirement expressed as a set of rules governing lists structured according to previous claims.

Claim 1.

According to claim 1 some of these operations use a value of a first list, one of those used to store run-time data, in deriving an extension list. Where the extension list contains at least one entry it is appended to the tail of the value of the first list then stored, forming a new stored value of the first list. Only one updating operation, to form a new stored value of the first list, may be in progress at any given time. The claim does not specify how this is to be achieved but a number of methods will be apparent thus each updating operation might initiate its successor, or might create conditions under which that initiation might be enabled.

Claims 1 and 2 provide means to prevent cross-talk, as was explained under “Concurrency” in part 2 of the technical paper given above, and under “Concurrency Control” in part 3 of that paper.

Claim 2.

Claim 2 provides a particular case of claim 1, in which a semaphore is used to ensure that no more than one updating operation, to update a particular list, can be in progress at any given time. According to these claims a semaphore is either claimed or unclaimed at any time; a test of a semaphore succeeds if the semaphore proves to be unclaimed at the time of testing, the test then setting the semaphore into the “claimed” state. These actions are said to be indivisible as no more than one such “test and set” operation can be in progress at any given time.

The claim provides a system in which a semaphore, used to protect against cross-talk, must be claimed successfully before a first value of the first list can be determined and used in deriving a new stored value of the same list, in place of the first value. At this point the semaphore may be released into the unclaimed state although this step is not included in the claim.

Claims 3 and 4.

Claim 3 provides means to control both cross-talk and regression. A first semaphore must be tested successfully before an updating operation can proceed to update a first list using values of a second list and, where applicable, of the first list. The second part of the claim, starting with the test of the second semaphore, is according to claim 2 and will prevent cross-talk in the updating of the first list provided that every access, to update that list, is controlled by the second semaphore, that semaphore to be claimed successfully before every update of the first list. In cases where the value of the first list plays no part in the derivation of the extension list the step of obtaining a value of this list may be omitted; claim 4 covers this but follows claim 3 in other respects.

Following successful claiming of the first semaphore the updating operation obtains the current value of the second list and may then start derivation of the extension list in cases where the nature of the derivation allows that. A second semaphore, safeguarding against cross-talk, is also claimed after the first semaphore has been claimed successfully; success of this second claiming action allowing the updating operation to obtain the current value of the first list.

After the second semaphore has been successfully claimed and after the value of the second list has been obtained the first semaphore is released into the “unclaimed” state. The updating operation will now complete the derivation of the extension list using the values of the first and second lists, and will append that extension list to the currently-stored value of the first list to form a new stored value of it.

The second semaphore may now be released into the “unclaimed” state, though this step is not specified in the claim.

Where the derivation of the extension list does not require a value of the first list the obtaining of a value of that list can be omitted from the procedure, as claimed in claim 4.

The procedure ensures that regression, due to faulty choice of values of the second list, is avoided. Regression was introduced under “Concurrency” in section 2 above and its prevention was discussed under “Concurrency Control” in section 3 above.

The use of the second semaphore also prevents the occurrence of cross-talk in the creation, within the equipment, of new stored values of the first list, provided that generation of these values is protected in all cases by prior testing of the second semaphore.

In parenthesis it will be noted that one semaphore may in some applications serve to protect against regression due to faulty choice of values of a number of lists, the semaphore claimed before obtaining values of these lists; it will also be noted that where a semaphore safeguards against cross-talk it may also protect against regression if claimed before a value of any second list is obtained. A single semaphore will then protect against both ills.

Clearly in the testing of semaphores it is necessary to avoid deadlocks; there are well-known ways of achieving this, notably by ensuring that any pair of mappings, designed to test a particular pair of semaphores, will always test them in the same time order, the first test to succeed before the second can be applied.

Claim 5.

This claim relates to equipment according to any claim or claims and in which an entry, of a stored list, will contain at least one set of data of which the content is not recorded when the entry is first appended to its stored list. An indicator, within the entry, then indicates that the set of data has not yet been recorded. When the content has been recorded the indicator is set to indicate that the set of data has become accessible to its readers. Each such set of data has an accompanying indicator used in this way.

This topic was discussed earlier; the technique allows a number of sets of data to be derived using the content of an entry or of the list containing it, these sets of data being recorded within that entry. A set of data, derived in this way, may itself contain similar sets of data each accompanied by its own indicator. A set of data may itself be regarded as an entry of a list.

Claim 6.

Claim 6 relates to equipment according to any claim or claims, and in which an entry of a first stored list includes means to address an entry of a second stored list. This latter entry may be either a particular entry, its identity independent of the time at which the addressing action takes place; or else it may be the latest entry, at the time of addressing, of the second stored list, its identity altering whenever the content of that stored list is altered. Where the occurrence of a single episode implies changes in the content of two stored lists, as was explained earlier, then the first technique, in which the identity is fixed, is used, thus identifying two entries which are related by the occurrence of the episode. Here an entry of a higher level list may contain pointers to entries in a number of lower level lists in a hierarchy, thus identifying a relationship between these entries

Where an entry further describes a time-varying population of episodes, as was also explained earlier, then the entry contains pointers to the latest entries of the stored lists each describing the past behaviour of such an episode. The identities of these latest entries may change as new entries arrive.

Claim 7.

This claim relates to equipment according to any other claim or claims and which employs a multi-processor configuration to perform mappings. Processors, operating concurrently to access instructions and data from memory units which also operate concurrently according to the claim, can improve on the response-time performance available using a single processor and a single memory unit. It is a particular advantage of the invention that programs, used to perform mappings, can readily be accommodated in different hardware configurations.

Claim 8.

This claim again relates to equipment according to any other claim or claims and incorporating simple means to limit the amount of storage capacity dedicated to any one stored list. The equipment might limit the number of entries which can be held, or might limit the amount of storage dedicated to such entries. The entries retained are the latest-appended entries of the list. Historic entries of a list may be lost when this technique is used; however the provision of sufficiently extensive storage will always yield a solution to the problem of memory recycling, and will prove increasingly attractive, for its simplicity, as ever-greater storage capacities become readily available.

A system of this kind might be used in conjunction with means of identifying the earliest-appended entry of a stored list remaining accessible to mappings.

Claim 9.

This claim relates to equipment according to any claim or claims and equipped to identify those entries, of lists stored according to any claim or claims, which will not again be read and which can therefore be discarded, thus allowing memory capacity to be recycled. According to this claim an entry must remain within a stored list while it belongs to the last-appended n entries of the list, where n is an integer chosen by a designer for control of that list; and while the entry has not belonged to these n entries for a period of time t, t again chosen by a designer to control the particular list; and while the entry remains accessible through an entry which remains stored.

Equipment according to this claim contains means to examine lists, starting from the highest level lists of hierarchies and proceeding downwards, to identify those entries which must, when examined according to these criteria, remain stored.

Claim 10.

This claim relates to equipment, according to any other claim or claims, in which the mechanisms by which mappings are initiated, or the rapidity with which mappings are performed, or both, can be varied in order to attain desired response-time performance.

Claim 11.

This claim relates to a method of specifying the requirement to which the behaviour of a real time system is to conform, it employs a set of rules, expressed in a language such as Prolog, to specify relationships to which entries, of lists organised according to any claim or claims, are to conform. By associating, with each such entry, data to indicate the time at which that entry was appended to its list it is possible to specify the requirements governing both the logical or functional behaviour and the response time performance. The claim is for equipment, of whatever design, constructed to meet a requirement expressed in this way.

I claim:

1. Equipment to control the course of a process, said process to provide a continuing service, said equipment to embody:
storage means, to store lists, said lists to describe past behaviour relating to said process and relating to control of the course of said process;
updating means, to perform updating operations, each of said updating operations to determine the value, at the time of said determination, of a first list drawn from said lists, to employ said value in deriving an extension list and to append said extension list to the tail of a value of said first list, said value that stored at the time of said appending action, thereby to create within said storage means a new stored value of said first list; said extension list to contain at least one entry;
exclusion means to ensure that no more than one of said updating operations, to create a new stored value of said first list, may be in progress at any given time.

2. Equipment according to claim 1 and to embody:
means to test a semaphore; said test succeeding, means to perform an updating operation according to claim 1, thus to create a new stored value of a first list according to said claim; said test of said semaphore to ensure that no more than one updating operation to create a new stored value of said first list, can be in progress at any given time, thereby to provide exclusion means according to claim 1.

3. Equipment according to claim 2 and equipped to perform action sequences, each action sequence to test a first semaphore; said test succeeding, said equipment to perform an updating operation to determine the value, at the time of said determination, of a second list drawn from said lists stored in said equipment; said updating operation also to test a second semaphore according to claim 2; said test of said second semaphore succeeding, said updating operation to determine the value, at the time of said determination, of a first list; said updating operation to employ said values, of said first and second lists, in deriving an extension list and in appending said extension list to the tail of a value of said first list according to the method of claim 2, said value the value stored at the time of said appending action; the list, formed by thus appending said extension list to said tail of said stored value, to be stored in place of said stored value to become the new stored value of said first list;
said extension list to contain at least one entry; said first and second lists drawn from said lists stored in said equipment according to claim 1;
said first semaphore to be released only after said value of said first list has been obtained and after said test of said second semaphore has succeeded, thereby to allow a subsequent action sequence, of said action sequences, to proceed to test, successfully, said first semaphore;
said semaphores employed to ensure that if a first updating operation obtains a value of said second list before a second updating operation obtains a value of said second list then said first updating operation will also create a new stored value of said first list before said second updating operation creates a new stored value of said first list.

4. Equipment according to claim 3 and in which the value of said first list, according to claim 3, plays no part in the derivation of an extension list according to claim 3, the step of obtaining a value of said first list omitted from claim 4, the procedure claimed in claim 3 also claimed in claim 4 save in that said step is omitted.

5. Equipment according to any claim or claims, an entry of a list stored according to claim 1 to contain an indicator, said indicator to indicate that a set of data is not yet recorded within said entry; means to record a set of data within said entry and subsequently to set said indicator to indicate that said set of data has been recorded within said entry.

6. Equipment according to any claim or claims;
an entry, of a first list drawn from lists stored according to claim 1, to provide means to perform an addressing action to address, and thus to read the content of, an entry of a second list also drawn from said lists, said entry of said second list to be either a specific entry of said second list or else to be the latest-appended entry, at the time of said addressing action, of said second list.

7. Equipment according to any claim or claims and adapted to employ computer instructions to control said equipment; means, within said equipment, to employ a first memory unit to provide access to a first set of said computer instructions or to a first set of data or to both, and to employ a second memory unit to provide access to a second set of said computer instructions or to a second set of data or to both, said first and said second memory units adapted to operate concurrently; wherein said first or said second set of data may include data contained within lists stored within said equipment according to claim 1.

8. Equipment according to any claim or claims and adapted to store a number of lists according to claim 1; said equipment adapted, in storing a list drawn from said number of lists, to provide means to limit the memory capacity dedicated to the storage of entries of said list.

9. Equipment according to any claim or claims; means, within said equipment, to assign to a list stored within said equipment a number n and a time duration t, said number and said time stored within said equipment; identification means, to identify within said equipment an entry to be discarded from said stored list, said entry to have been absent from the last-appended n entries of said list throughout a period of time exceeding in duration said time duration t; said entry neither contained within any retained entry of any other stored list of said equipment nor referenced within such a retained entry; wherein a first entry is said to be referenced by a second entry if said second entry includes means to address said first entry; and wherein a retained entry is an entry identified, according to said identification means, not to be discarded from the stored list to which said retained entry belongs.

10. A method for use in realising equipment according to any claim or claims, said method to employ a computer program to control said equipment thereby to derive an entry or a list of entries and to append said entry or list of entries to a list contained within said lists according to claim 1; said equipment adapted to allow variation in the means whereby the action of said computer program is initiated, or to allow variation in the speed of execution of said program, or to allow variation in both.

11. Equipment realised to meet a requirement expressed as a set of rules, said rules to state logical properties required of a number of lists stored according to any previous claim or claims and of the times at which extension lists are appended to said lists according to any claim or claims:
